(19) United States
(12) Patent Application Publication
(10) Pub. No.: US 2007/0251096 A1
(43) Pub. Date: Nov. 1, 2007

(54) Egg breaking device incorporating a durable and rubberized exterior covering

(76) Inventor: Richard Smith, Rochester Hills, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/414,489

(22) Filed: Apr. 28, 2006

(51) Int. Cl. A47J 43/26

(52) U.S. Cl. 30/120.5

(57) ABSTRACT

An egg breaking device for use with an individual in-shell egg having a body including first and second arcuately shaped and pivotally attachable halves, collectively defining a three-dimensional oval interior encapsulating therebetween the in-shell egg. An aperture is defined between opposing surfaces associated with the pivotally attachable halves, the aperture exposing a portion of the egg shell such that, upon striking the device against a hard surface, the shell is fractured and the in-shell contents evacuated from the body and through the aperture. Finger access apertures are defined at opposite end locations associated with the body and, following removal of the egg yolk and albumen, facilitate removal of the remaining egg shell.

### BACKGROUND OF THE INVENTION

1. Field of the Invention

The present invention relates generally to devices utilized in the breaking of an eggshell to retrieve the albumen and yolk contents therefrom. More specifically, the present invention teaches a rubberized and clamshell shaped device, enclosing about an exterior of an in-shell egg, at least one intermediate area of the rubberized body being removed to provide a striking surface for breaking the shell and permitting the viscous contents thereof to be emptied. An additional feature includes the provision of additional end apertures in the clamshell body, these being sized to permit a user's fingers to facilitate ejection of the remaining shell contents.

2. Description of the Prior Art

The prior art is well documented with examples of breaking devices. The objective in each instance is the ability to quickly and effectively break an in-shell egg and evacuate its fluidic contents. A further objective is the ability to quickly and efficiently dispose of the remaining shell portion following retrieval of the yolk and albumen.

A first example selected from the prior art is set forth in Christianson, U.S. Pat. No. 6,675,701, and which teaches a pair of clamshell disposed members, separated by a common hinge. The top member includes a plurality of underside located and projecting ribs, these seating within associated cavities which are located upon the bottom member's upper surface. Of note, a plurality of eggs are supported in individualized fashion within the cavities of Christiansen.

Talbot, U.S. Pat. No. 4,542,584, illustrates a pair of complementary egg supporting container parts, from which extend a pair of hingedly connected elongated handles, and in order to displace the egg container parts between closed abutting and an open separated positions. Egg cutting members extend inwardly in mating and adjoining fashion connected to the egg container parts and, upon opening cutter members to the position shown in FIG. 8, outwardly displace the shell in the manner shown to allow the interior yolk and albumen to be downwardly released.

U.S. Pat. No. 6,279,232, issued to Cho, teaches an apparatus for removing an eggshell, which provides a body and handle for holding an egg softly by linkage between them. A removing plate breaks the eggshell with the handle, and an operating device expands the removing plate as to extract the contents in the egg and to render more convenient the removal of the eggshell.

Finally, U.S. Pat. No. 2,729,254, issued to McLaughlin, teaches an egg opener having two rigid jaws, each being slightly less than a half of a circle and having their concavities mutually facing. A spring interconnects the jaws and tends to separate them. A plurality of short needles are spaced along and rigidly secured to the jaws and extend generally radially inwardly therefrom. Two receiving cage portions are secured to each of the jaws and extending toward each other and away from the plane of the needles. In this fashion, an egg placed in contact with the cage portions will position the needles properly to sever the top of the shell thereof and to hold the same when severed. A pair of handles are secured to the ends of the jaws remote from the interconnecting portion.

### SUMMARY OF THE PRESENT INVENTION

The present invention discloses an egg breaking device for use with an individual in-shell egg and which facilitates easy and quick removal of the egg contents (e.g. yolk and albumen) while retaining the broken shell. The body includes first and second arcuately shaped and pivotally attachable halves, typically constructed of a rubberized material, and collectively defining a three-dimensional oval interior encapsulating therebetween the in-shell egg.

An aperture is defined between opposing surfaces associated with the pivotally attachable halves, the aperture exposing a portion of the egg shell such that, upon striking the device against a hard surface, the shell is fractured and the in-shell contents evacuated from the body and through the aperture. Finger access apertures are defined at opposite end locations associated with the body and, following removal of the egg yolk and albumen, facilitate removal of the remaining egg shell.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective view of an individual egg breaking device according to a first preferred embodiment of the present invention;

FIG. 2 is a side plan view of the egg breaking device of FIG. 1;

FIG. 3 is a perspective view of the egg breaking device according to a second preferred embodiment of the present invention;

FIG. 4 is a top plan view of the egg breaking device of FIG. 3; and

FIG. 5 is an end plan view of the device of FIG. 3 according to a slightly modified variant and showing the wedge shaped aperture relocated to a further position associated with a selected pivotally associating half according to the present invention.

### DETAILED DESCRIPTION OF THE PREFERRED EMBODIMENTS

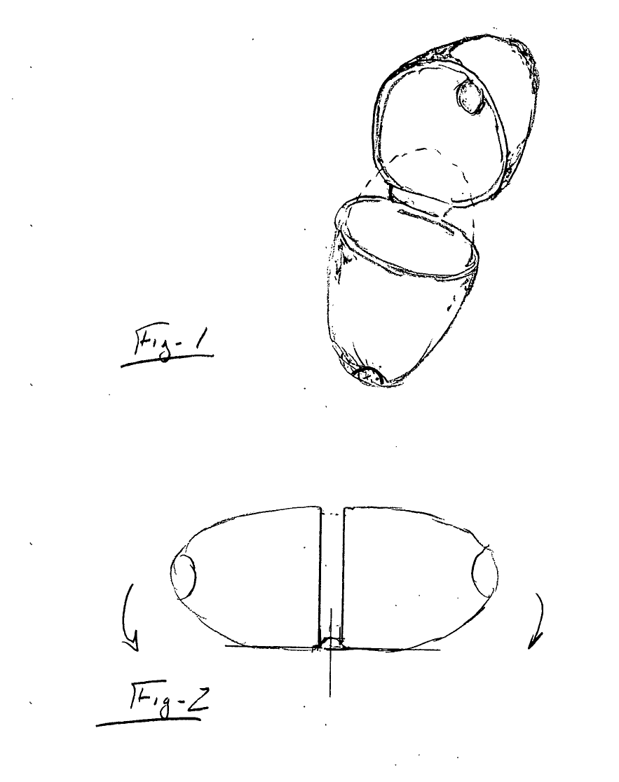

Referring now to FIGS. 1 and 2, an egg breaking device is illustrated at 10 according to a first preferred embodiment of the present invention. As previously described, the present invention discloses a rubberized and clamshell shaped device, enclosing about an exterior of an in-shell egg, from which at least one intermediate area of the rubberized body is removed to provide a striking surface for breaking the shell and to permit the viscous contents thereof to be emptied while retaining the broken shell contents for separate removal and disposal.

An egg breaking device 10 has a body including first 12 and second 14 arcuately (in this variant dome) shaped and pivotally attachable halves. Each half 12 and 14 exhibits a specified shape and size (such that the halves in cooperation are capable of substantially encapsulating a standard ovarian egg of given species and/or variety). Each half 12 and 14 is constructed of a rubberized (typically black) material of selected thickness, and such that the halves are assembled together to collectively define a three-dimensional oval interior encapsulating therebetween an in-shell egg, see as further referenced in outline at 16 in FIG. 1.

An aperture is defined between opposing surfaces 18 and 20 associated with the pivotally attachable halves 12 and 14, in the first embodiment extending perpendicularly (see arrow 22 in FIG. 2) relative to a lengthwise extending centerline (see further arrow 24 in FIG. 2) extending along the body, and such that the aperture exposes an equatorial extending portion of the egg shell 16. Upon striking the device against a hard surface, portions of the egg 16 covered by the rubberized material defining the first and second halves 12 and 14 are substantially protected, whereas the exposed portion of the shell is fractured, and the in-shell contents evacuated from the body and through the aperture. The exposed aperture area may further be of any dimension, such as ¼″ or ½″ inches in width (and corresponding to a 4¼″ circumference typically corresponding to a grade A large chicken egg), the sizing further being accomplished by spacing the gap between the opposing edges of the (see also widened surface 20′ for increasing the width of the exposed eggshell area).

The pivotally attachable halves further include such as a plasticized living hinge 26 (see FIG. 2) interposed between contiguous locations associated with the clamshell foldable halves 12 and 14. As will be discussed in a further variant, the living hinge 26 depicts only one possible mechanism for pivotally securing together the first and second three-dimensional defining body portions, such additional mechanism including, without limitation, a spring or other contemplated hinge mechanism for holding the first and second body halves together while permitting them their required degree of articulating motion.

Also provided are additional apertured and finger access portions, see edge defining walls 28 and 30, defined at converging end locations associated with each of the halves 12 and 14. As previously described, the finger defined apertures facilitate removal of the remaining egg shell after removal of the yolk and albumen.

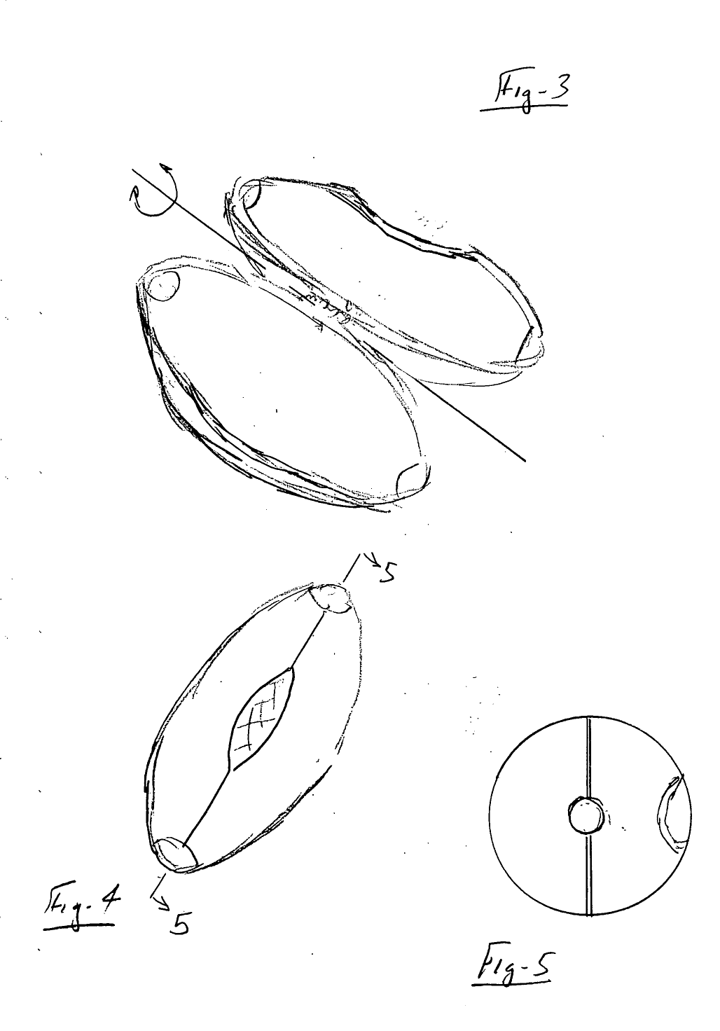

Referring now to FIGS. 3-5, an egg breaking device is illustrated at 32 according to a second preferred embodiment and for use with an individual in-shell egg. Similar to the first disclosed variant, the body including first and second arcuately shaped and pivotally attachable halves 34 and 36, each exhibiting a specified shape and size and constructed of a rubberized material of selected thickness, and again being assembled together to collectively define a three-dimensional oval interior encapsulating therebetween the in-shell egg.

In the further variant, an aperture is defined between opposing surfaces, see arcuate and wedge shape defining surfaces 38 and 40, associated with the pivotally attachable halves 34 and 36, respectively, these extending in parallel relative to a lengthwise extending centerline (see at 42 in FIG. 4) along the body. The aperture created exposes a lengthwise extending and wedge shaped portion of the egg shell, see further at 44 in FIG. 4 and such that, upon striking the device against a hard surface, the shell is fractured and the in-shell contents evacuated from the body and through the aperture. As further shown in FIG. 5, an end plan view of the device of FIG. 3 is shown according to a slightly modified variant, and by which the wedge shaped aperture is relocated to a further position (see as defined by surfaces 38′ and 40′) associated with a selected pivotally associating half (e.g. half 36′ or half 34′).

As described previously, the pivotally attachable halves 34 and 36 each exhibit a specified shape and size, and may include such as a spring 46 interposed between contiguous locations associated with the halves. Again, any of a number of other hingedly defining mechanisms, such as including living hinges or the like, may alternatively be employed within the scope of the invention. Also, additional apertured and finger access portions are defined at 48 and 50 in converging end fashion associated with each of the halves, the apertures again providing access therethrough by the user's fingers to facilitate removal of the eggshell, following breaking and evacuation of the yolk and albumen. It has been found through examination that, if dropped from above a user's head, the shell of the egg supported by the present device will only crack proximate its exposed location, the inner fluidic yolk remaining in place until dispensed therefrom.

Having described my invention, other and additional preferred embodiments will become apparent to those skilled in the art to which it pertains, and without deviating from the scope of the appended claims.

I claim:

1. An egg breaking device for use with an individual in-shell egg, comprising:
a body including first and second arcuately shaped and pivotally attachable halves, collectively defining a three-dimensional oval interior encapsulating therebetween the in-shell egg; and
an aperture defined between opposing surfaces associated with said pivotally attachable halves and exposing a portion of the egg shell such that, upon striking the device against a hard surface, the shell is fractured and the in-shell contents evacuated from the body and through the aperture.

2. The egg breaking device as described in claim 1, said pivotally attachable halves each exhibiting a specified shape and size and further comprising a rubberized material exhibiting a selected thickness.

3. The egg breaking device as described in claim 1, said pivotally attachable halves each exhibiting a specified shape and size, a spring being interposed between contiguous locations associated with said halves.

4. The egg breaking device as described in claim 1, said pivotally attachable halves each exhibiting a specified shape and size, a plasticized living hinge being interposed between contiguous locations associated with said halves.

5. The egg breaking device as described in claim 1, further comprising said pivotally attachable location extending perpendicularly relative to a lengthwise extending centerline along said body.

6. The egg breaking device as described in claim 5, further comprising opposing edges associated with said first and second pivotally attachable halves being spaced a distance from each other and exposing an equatorial extending portion of the in-shell egg.

7. The egg breaking device as described in claim 1, further comprising said pivotally attachable location extending in parallel relative to a lengthwise extending centerline extending along said body.

8. The egg breaking device as described in claim 7, further comprising arcuate and lengthwise extending edges associated with said first and second halves exposing a corresponding lengthwise extending and wedge shaped portion of the in-shell egg.

9. The egg breaking device as described in claim 1, further comprising additional apertured and finger access portions defined in converging end locations associated with each of said halves.

10. The egg breaking device as described in claim 1, said pivotally attachable halves each exhibiting a specified shape and size and further comprising a black rubberized material exhibiting a specified flexibility.

11. An egg breaking device for use with an individual in-shell egg, comprising:
a body including first and second arcuately shaped and pivotally attachable halves, each exhibiting a specified shape and size and constructed of a rubberized material of selected thickness, said halves being assembled together to collectively define a three-dimensional oval interior encapsulating therebetween the in-shell egg; and
an aperture defined between opposing surfaces associated with said pivotally attachable halves and extending perpendicularly relative to a lengthwise extending centerline along said body, said aperture exposing an equatorial extending portion of the egg shell such that, upon striking the device against a hard surface, the shell is fractured and the in-shell contents evacuated from the body and through the aperture.

12. The egg breaking device as described in claim 11, said pivotally attachable halves each exhibiting a specified shape and size, a spring being interposed between contiguous locations associated with said halves.

13. The egg breaking device as described in claim 11, said pivotally attachable halves each exhibiting a specified shape and size, a plasticized living hinge being interposed between contiguous locations associated with said halves.

14. The egg breaking device as described in claim 1, further comprising additional apertured and finger access portions defined in converging end locations associated with each of said halves.

15. An egg breaking device for use with an individual in-shell egg, comprising:
a body including first and second arcuately shaped and pivotally attachable halves, each exhibiting a specified shape and size and constructed of a rubberized material of selected thickness, said halves being assembled together to collectively define a three-dimensional oval interior encapsulating therebetween the in-shell egg; and
an aperture defined between opposing surfaces associated with said pivotally attachable halves and extending in parallel relative to a lengthwise extending centerline along said body, said aperture exposing a lengthwise extending and wedge shaped portion of the egg shell such that, upon striking the device against a hard surface, the shell is fractured and the in-shell contents evacuated from the body and through the aperture.

16. The egg breaking device as described in claim 15, said pivotally attachable halves each exhibiting a specified shape and size, a spring being interposed between contiguous locations associated with said halves.

17. The egg breaking device as described in claim 15, said pivotally attachable halves each exhibiting a specified shape and size, a plasticized living hinge being interposed between contiguous locations associated with said halves.

18. The egg breaking device as described in claim 15, further comprising additional apertured and finger access portions defined in converging end locations associated with each of said halves.
